(19) United States
(12) Patent Application Publication
(10) Pub. No.: US 2009/0284517 A1
(43) Pub. Date: Nov. 19, 2009

(54) Display Apparatus

(75) Inventors: Ming-Huang Chuang, Hsinchu (TW); Chun-Hung Kuo, Hsinchu (TW); Chun-Huai Li, Hsinchu (TW); Hung-Wei Tseng, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/243,531

(22) Filed: Oct. 1, 2008

(30) Foreign Application Priority Data
May 16, 2008 (TW) 97118098

(51) Int. Cl. G06F 3/038

(52) U.S. Cl. 345/212

(57) ABSTRACT

A display apparatus is provided. The display apparatus includes a display module, a plurality of driving modules, and a plurality of sensing modules. The display module has a first side and a second side opposite the first side. The driving modules are respectively adjacent to the first and second sides and are electrically connected to the display module. The sensing modules are respectively adjacent to the first and second sides, in which the sensing modules are configured to sense an environment status surrounding the display apparatus to modulate the display module from the first status to the second status. One of the driving modules adjacent to the first side is substantially opposite to one of the sensing modules adjacent to the second side, with respect to the display module.

This application claims priority to Taiwan Patent Application No. 097118098 filed on May 16, 2008, the content of which is incorporated herein by reference in its entirety.

### CROSS-REFERENCES TO RELATED APPLICATIONS

Not applicable.

### BACKGROUND OF THE INVENTION

1. Field of the Invention

The present invention relates to a display apparatus. More particularly, the present invention relates to a display apparatus having a plurality of sensing modules.

2. Descriptions of the Related Art

Over recent years, digitalized display apparatuses such as liquid crystal displays (LCDs) have developed rapidly. Currently, LCDs have gradually replaced conventional cathode ray tube (CRT) displays as the mainstream product in the display market due to their advantages, such as low power consumption, light weight, slim profile and high definition.

In conventional display apparatuses, a driving module such as a vertical scan driver is usually integrated adjacent to the display module to drive the display module. Furthermore, as the functions of the digital products have become increasingly diversified, additional sensing modules may be disposed adjacent to the display module of the display apparatus, for example, thermal sensors, ambient light sensors, UV sensors and the like. The ambient light sensor senses the ambient illumination around the display module, so that the display apparatus can dynamically adjust the backlight luminance according to the changes of the environmental ambient light, thereby improving the contrast ratio and reducing power consumption. More specifically, when the ambient light sensor senses a decrease in the ambient light, the backlight luminance of the may be decreased by the display apparatus to improve the contrast ratio and lower power consumption. On the contrary, when the ambient light sensor senses an increase in the ambient light, the backlight luminance of the may be increased by the display apparatus to maintain a constant contrast ratio.

However, to make the sensing results of the ambient light of the display module more uniform and accurate, at least two independent sets of ambient light sensors have to be disposed at the opposite diagonal positions on the sides of the display module respectively. To illustrate the relative positions of the ambient light sensors, the display module and the driving module in the display apparatus more clearly, a single-side driving scheme and a dual-side driving scheme will be described hereinafter with reference to the attached drawings.

FIG. 1 illustrates a conventional display apparatus adopting a single-side driving scheme. The display apparatus 1 comprises a display module 11, ambient light sensors 13, 15, and a driving module with a plurality of shift registers. For purpose of simplicity, only four shift registers 171, 173, 175 and 177 are depicted in FIG. 1. Now, functions of the individual elements of the display apparatus 1 will be described first. The display module 11 comprises a plurality of display rows, each of which comprises a gate line 111 and a plurality of pixel units 113 connected to the corresponding gate line 111. Each of the shift registers 171, 173, 175, 177 is electrically connected to the corresponding display row respectively, and drives the pixel units 113 via the gate line 111 in response to an upward-driving signal 10, a clock (VCK) signal, an inverted clock ( V̅C̅K̅) signal, a driving direction (U2D/D2U) signal, a maximum voltage VDD of the display apparatus 1 and a minimum voltage VSS of the display apparatus 1.

In more detail, upon the shift register 171 receiving the upward-driving signal 10, each of the shift registers 171, 173, 175, 177 activates the pixel units 113 in the corresponding display row in sequence via the gate line 111 in response to the upward-driving signal 10 as well as the VCK signal, the V̅C̅K̅ signal, the U2D/D2U signal, the maximum voltage VDD and the minimum voltage signal VSS received by the corresponding shift register. Likewise, the driving module of the display apparatus 1 may also receive a downward-driving signal 12 via the shift register 177, so that each of the shift registers 177, 175, 173, 171 will activate the pixel units 113 in the corresponding display row in sequence.

Furthermore, the display module 11 has a first side 115 and a second side 117 opposite the first side 115. The shift registers 171, 173, 175, 177 and the ambient light sensor 13 are all disposed on the first side 115, while the ambient light sensor 15 is disposed on the second side 117 to sense the ambient light surrounding the display module 11. To make the sensing results of the ambient light of the display module 11 more uniform and accurate, the ambient light sensors 13 and 15 are disposed at diagonal positions on both sides of the display module as shown in FIG. 1. Unfortunately, because the ambient light sensor 13 and the shift registers 171, 173, 175, 177 are all located on the same side, they will suffer from signal interference from each other and occupy a large space on this side, causing difficulty in the assembly process.

FIG. 2 illustrates a conventional display apparatus 2 adopting a dual-side driving scheme. The display apparatus 2 comprises a display module 11, ambient light sensors 13, 15, a driving module with a plurality of shift registers (for purpose of simplicity, only four shift registers 171, 173, 175 and 177 are denoted in FIG. 2), and the other driving module with a plurality of shift registers (for purpose of simplicity, only four shift registers 271, 273, 275 and 277 are denoted in FIG. 2). Hereinafter, only the differences between the display apparatus 2 and the display apparatus 1 will be described, with identical portions omitted.

The display apparatus 2 differs from the display apparatus 1 primarily in that the driving module with the plurality of shift registers 271, 273, 275, 277 is disposed on the second side 117 of the display apparatus 2. The shift registers 271, 273, 275, 277 have the same functions as the shift registers 171, 173, 175, 177. The two driving modules located on the first side 115 and the second side 117 are configured to receive the upward-driving signal 10 simultaneously via the shift register 171 and the shift register 271 respectively to drive the pixel units 113. Likewise, the two driving modules located on the first side 115 and the second side 117 are configured to receive the downward-driving signal 12 simultaneously via the shift register 177 and the shift register 277 respectively to drive the pixel units 113. The display apparatus adopting the dual-side driving scheme is advantageous in that it eliminates the delay of the gate signal caused by a heavily loaded gate line, and is able to make a remedy when a shift register at either side fails. For example, in case the shift register 173 fails, the shift register 273 still works properly to perform the driving function so that the display apparatus 2 may continue to operate properly. However, because the ambient light sensors 13, 15 are located on the same side as the shift registers 171, 173, 175, 177 and the shift registers 271, 273, 275, 277 respectively, the signals thereof will interfere each other and a large space will be occupied at respective sides, thereby causing difficulty in the assembly process.

The display apparatuses described above all have ambient light sensors integrated into the display module to optimize the images generated by the display apparatus. However, at least one sensor module is disposed between a driving module and the display module in both the display apparatus 1 and the display apparatus 2. This tends to exacerbate the signal interference therebetween and increase the width of the display apparatus, thereby causing difficulty in the assembly process.

In view of this, it is highly desirable in the art to integrate a sensing module with a display module in a way that may reduce signal interference from each other and decrease the difficulty encountered in assembling the display apparatus without enlarging the space occupied by the display apparatus.

### SUMMARY OF THE INVENTION

One objective of this invention is to provide a display apparatus comprising a display module, a plurality of driving modules and a plurality of sensing modules. The display module has a first side and a second side opposite the first side. The driving modules are respectively disposed next to the first side and the second side and are electrically connected to the display module. The sensing modules are respectively disposed next to the first side and the second side, and are electrically connected to the display module to sense an environment status surrounding the display apparatus. One of the driving modules disposed next to the first side, with reference to the display module, is substantially opposite to one of the sensing modules disposed next to the second side.

Another objective of this invention is to provide a display apparatus comprising a display module, a plurality of driving modules, a plurality of sensing modules and a processing module. The display module has a first side and a second side opposite the first side. The plurality of driving modules is respectively disposed next to the first side and the second side, and is electrically connected to the display module. The plurality of sensing modules is respectively disposed next to the first side and the second side, and is configured to sense the environment status surrounding the display apparatus. The process module is electrically connected to the display module and the sensing modules, and is configured to modulate the display module from the first status to the second status in response to the environment status. One of the driving modules disposed next to the first side, with reference to the display module, is substantially opposite to one of the sensing modules disposed next to the second side.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a conventional display apparatus adopting a single-side driving scheme;

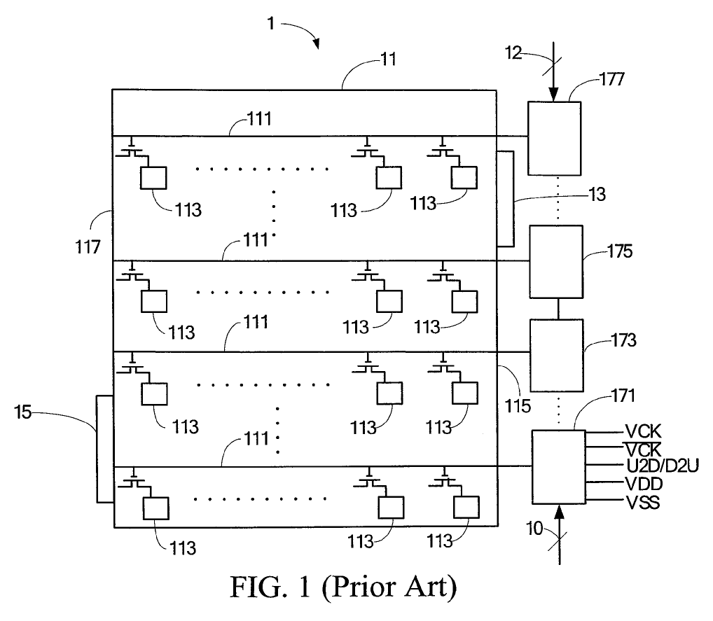

FIG. 2 is a schematic view of a conventional display apparatus adopting a dual-side driving scheme;

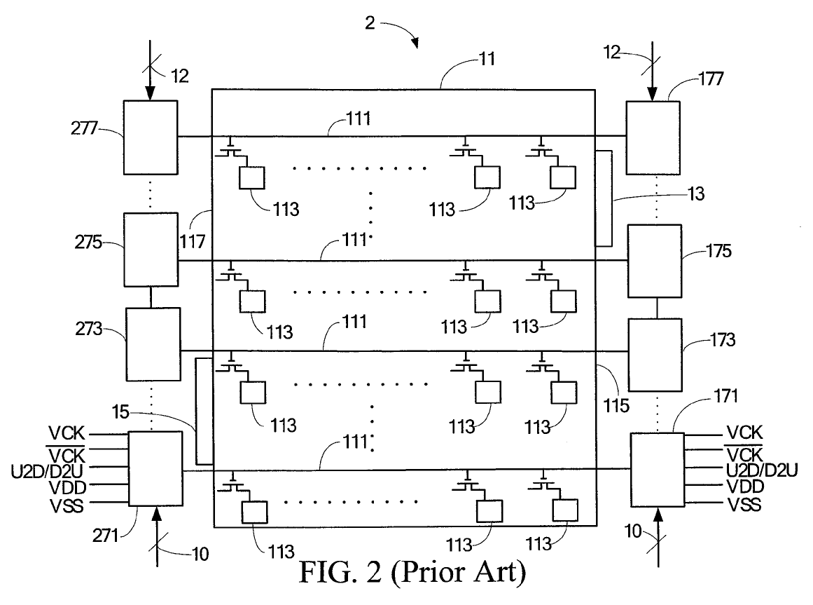

FIG. 3 is a schematic view of the first embodiment of this invention; and

FIG. 4 is a schematic view of the second embodiment of this invention.

### DESCRIPTION OF THE PREFERRED EMBODIMENT

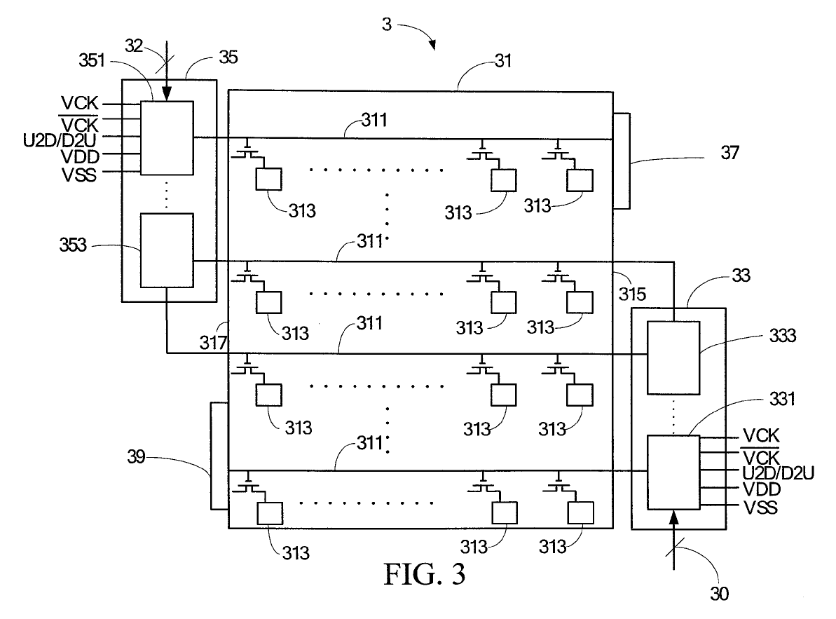

FIG. 3 depicts a display apparatus according to a first embodiment of this invention. The display apparatus 3 may be a low temperature polysilicon liquid crystal display (LTPS-LCD). However, the display apparatus 3 is not merely limited thereto, and this invention is applicable to any digital display apparatus which requires a driving module to drive the pixel units arranged in an array. The display apparatus 3 comprises a display module 31, a plurality of driving modules 33, 35 (for purpose of simplicity, only the driving modules 33, 35 are depicted in this preferred embodiment), and a plurality of sensing modules 37, 39 (for purpose of simplicity, only the sensing modules 37, 39 are depicted in this preferred embodiment). The sensing modules of the display apparatus 3 may be thermal sensors, ambient light sensors, UV sensors or other elements with a sensing capability.

The display module 31 has a first side 315 and a second side 317 opposite the first side 315. The driving module 33 and the driving module 35 are disposed next to the first side 315 and the second side 317 respectively and electrically connected to the display module 31 to drive the display module 31. The sensing module 37 and the sensing module 39 are disposed next to the first side 315 and the second side 317 respectively and are electrically connected to the display module 31 to sense the environment status surrounding the display apparatus 3, so that the output status of the backlight of the display module 31 can be modulated from the first status to the second status in response to the change in the environment status. One of the driving modules disposed next to the first side 315 is opposite to one of the sensing modules disposed next to the second side 317 with respect to the display module 31.

For example, in the first embodiment, each of the sensing modules 37, 39 is an ambient light sensor configured to sense the ambient light surrounding the display apparatus 3. In response to the change of the ambient light, the display module 31 dynamically modulates the backlight luminance to improve the contrast ratio and reduce the power consumption thereof. When the sensing module 37 and/or the sensing module 39 senses a decrease in the ambient illumination, the backlight luminance of the display apparatus 3 may be decreased to improve the contrast ratio and reduce the power consumption. On the contrary, when the sensing module 37 and/or the sensing module 39 senses an increase in the ambient illumination, the backlight luminance of the display apparatus 3 may be increased to maintain a constant contrast ratio. Here, the process of increasing or decreasing the backlight luminance represents a process of modulating the backlight output of the display module 31 from the first status to the second status.

Furthermore, FIG. 3 illustrates the driving module 33, the driving module 35, the sensing module 37 and the sensing module 39, which are disposed next to the first side 315 and the second side 317 respectively, with the driving module 33 and the sensing module 39 opposite each other with respect to the display module 31. The driving module 35 and the sensing module 37 is opposite each other with respect to the display module 31. With this arrangement, the driving modules 33, 35 and the sensing modules 37, 39 will not overlap each other at a same side. Hereinafter, the structures of the individual modules of the display apparatus 3 will be further described in detail.

In this preferred embodiment, the driving modules 33 and 35 are configured to drive the display module 31 in a series sequence. In more detail, the display module 31 comprises a plurality of display rows, each of which comprises a gate line 311 and a plurality of pixel units 313 connected in parallel via the gate line 311. Both the driving modules 33 and 35 comprise a plurality of shift registers connected in series, each of which is electrically connected to a respective display row to drive pixel units 313 thereof via the corresponding gate line 311.

In more detail, in an upward-driving process for example, the driving module 33 may be considered as the first driving module while the driving module 35 is considered as the last driving module according to the driving sequence. On the other hand, the sensing module 39 may be considered as the first sensing module while the sensing module 37 is considered as the last sensing module. The shift registers of each driving module at least comprises a first shift register and a last shift register. The first shift register 331 of the driving module 33 is configured to receive an upward-driving signal 30, a clock (VCK) signal, an inverted clock ( V̅C̅K̅) signal, a driving direction (U2D/D2U) signal, a maximum voltage VDD of the display apparatus 3 and a minimum voltage VSS of the display apparatus 3. The first shift register 331 is also configured to drive the plurality of pixel units 313 of the corresponding display row via the gate line 311 in response to those received signals. It should be noted that all of the shift registers included in the driving modules are able to receive the same kinds of signals as those received by the first shift register 331. For simplicity, only the shift registers 331 and 351 are depicted with the detailed signal lines in FIG. 3. That is, other shift registers shown on the same side as the shift register 331 and the shift register 351 respectively receive the same kinds of signals as those received by the shift register 331 and 351 respectively, which may be readily appreciated by those of ordinary skill in the art and will not be further described herein.

Upon receiving the upward-driving signal 30 by the first shift register 331 of the driving module 33, the shift registers of the driving module 33 may activate the pixel units 313 of respective display rows in sequence via respective gate lines 111 in response to the upward-driving signal 30 along with their respective VCK signals, V̅C̅K̅ signals, U2D/D2U signals, maximum voltage VDD and minimum voltage VSS received by the shift registers. Furthermore, the last shift register 333 of the driving module 33 is electrically connected to the first shift register of the next driving module (i.e., the first shift register 353 of the driving module 35) via two gate lines. In this way, the upward-driving signal 30 is transmitted from the last shift register 333 of the driving module 33 to the first shift register 353 of the driving module 35. In other words, the two adjacent driving modules in the display apparatus 3 are connected in series via two display rows of the display module 31.

Furthermore, upon receiving the upward-driving signal 30 from the last shift register 333 of the driving module 33 by the first shift register 353 of the driving module 35, each of the shift registers of the driving module 35 may activate the pixel units 313 of the respective display rows in sequence via respective gate lines 111 in response to the upward-driving signal 30 along with their respective VCK signal, V̅C̅K̅ signal, U2D/D2U signal, maximum voltage VDD and minimum voltage VSS received by the corresponding shift register. On the other hand, the last shift register 351 of the driving module 35 may be used to receive a downward-driving signal 32 to drive the pixel units 313.

The function of the downward-driving signal 32 is similar to that of the upward-driving signal 30 except for the driving sequence. Hence, the method of the downward-driving signal 32 functions will be readily appreciated upon reviewing the above description of the upward-driving signal 30, and thus will not be further described herein.

It should be further noted that in other embodiments, the sensing modules of the display apparatus 3 may also be electrically connected to a processing module (not shown in FIG. 3) instead of the display module 31. The processing module is electrically connected to the display module and the plurality of sensing modules to drive the display module. Upon sensing the environment status surrounding the display apparatus 3, the sensing modules transmit the sensing results to the processing module which may modulate the status of the display module 31 from the first status to the second status according to the environment status. The status modulation set forth herein is just the same as what is described above and thus will not be further described.

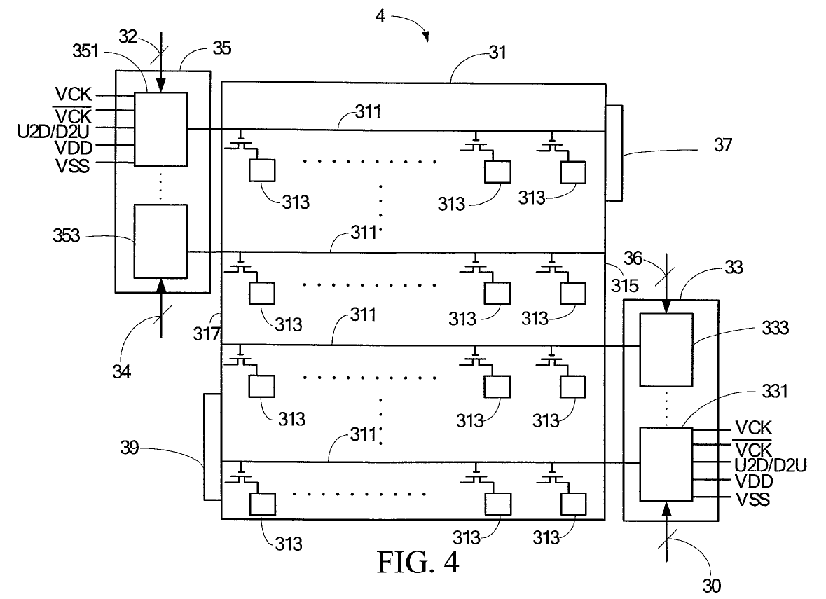

FIG. 4 illustrates a display apparatus according to the second embodiment of this invention. The display apparatus 4 may be, for example but not limited to, an LTPS-LCD. The display apparatus 4 comprises a display module 31, a plurality of driving modules 33, 35 (for purpose of simplicity, only the driving modules 33, 35 are depicted in this preferred embodiment), and a plurality of sensing modules 37, 39 (for purpose of simplicity, only the sensing modules 37, 39 are depicted in this preferred embodiment). The sensing modules of the display apparatus 4 may be thermal sensors, ambient light sensors, UV sensors or other elements with a sensing capability.

The following description will focus on the differences between the display apparatus 4 and the display apparatus 3, with identical portions omitted herein. As shown, the driving modules of the display apparatus 4 are independently disposed next to the first side 315 and the second side 317 respectively. In other words, the driving modules located on opposite sides are not connected in series with each other, and are configured to receive an upward-driving signal and a downward-driving signal respectively to drive a plurality of corresponding pixel units 313.

For example, in an upward-driving process, the first shift register 331 of the driving module 33 is configured to receive an upward-driving signal 30, so that each of the shift registers in the driving module 33 drives pixel units 313 of a respective display row in response to the upward-driving signal 30. The first shift register 353 of the driving module 35 is configured to receive the upward-driving signal 34, so that each of the shift registers in the driving module 35 drives pixel units 313 of a respective display row in response to the upward-driving signal 34.

Likewise, in a downward-driving process, the last shift register 351 of the driving module 35 is configured to receive a downward-driving signal 32, so that each of the shift registers in the driving module 35 drives the pixel units 313 of a respective display row in response to the downward-driving signal 32. The last shift register 333 of the driving module 33 is configured to receive a downward-driving signal 36, so that each of the shift registers in the driving module 33 drives the pixel units 313 of a respective display row in response to the downward-driving signal 36.

It should be further noted that in other embodiments, the sensing modules of the display apparatus 4 may also be electrically connected to a processing module (not shown in FIG. 4) instead of the display module 31. The processing module is electrically connected to the display module and the plurality of sensing modules to drive the display module. Upon sensing an environment status surrounding the display apparatus 3, the sensing modules transmit the sensing results to the processing module which may modulate the status of the display module 31 from the first status to the second status according to the environment status. The status modulation set forth herein is just the same as what is described above and thus will not be described again.

In summary, the driving modules and the sensing modules of this invention are disposed next to the first side and the second side of the display module respectively. One of the driving modules disposed next to the first side is substantially opposite to one of the sensing modules disposed next to the second side with respect to the display module. With such an arrangement, the sensing modules and the driving modules in the display apparatus of this invention will not overlap with each other on both sides of the display module. This arrangement prevents the signal interference between the sensing modules and the driving modules, reduces the area occupied by the driving modules and sensing modules of the resulting display apparatus, and decreases the difficulty suffered in the assembling process of the display apparatus.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A display apparatus, comprising:
a display module having a first side and a second side opposite to the first side;
a plurality of driving modules respectively disposed next to the first side and the second side, the plurality of driving modules being electrically connected to the display module; and
a plurality of sensing modules respectively disposed next to the first side and the second side, the plurality of sensing modules being electrically connected to the display module to sense an environment status surrounding the display apparatus;
wherein one of the driving modules disposed next to the first side, with reference to the display module, is substantially opposite to one of the sensing modules disposed next to the second side.

2. The display apparatus as claimed in claim 1, wherein the driving modules comprise a first driving module and a last driving module, the sensing modules comprise a first sensing module and a last sensing module, the first driving module is substantially opposite to the first sensing module, and the last driving module is substantially opposite to the last sensing module.

3. The display apparatus as claimed in claim 2, wherein the driving modules are adapted to drive the display module in a series sequence.

4. The display apparatus as claimed in claim 3, wherein the display module comprises a plurality of display rows, and the two adjacent driving modules are connected in series via two of the display rows of the display module.

5. The display apparatus as claimed in claim 4, wherein each of the display rows comprises a plurality of pixel units mutually connected in parallel via a gate line, each of the driving modules comprises a plurality of shift registers mutually connected in series, and each of the shift registers is electrically connected to the corresponding display row, so as to drive the pixels units of the corresponding display row via the corresponding gate line.

6. The display apparatus as claimed in claim 5, wherein each of the driving modules comprises a first shift register and a last shift register, wherein:
the last shift register of the first driving module is electrically connected to the first shift register of the driving module next to the first driving module via two gate lines;
the first shift register of the first driving module is configured to receive an upward-driving signal; and
the last shift register of the last driving module is configured to receive a downward-driving signal.

7. The display apparatus as claimed in claim 2, wherein the display module comprises a plurality of display rows, each of the driving modules comprises a plurality of shift registers mutually connected in series, and each of the shift registers is electrically connected to and is configured to drive the corresponding display row.

8. The display apparatus as claimed in claim 7, wherein each of the display rows comprises a plurality of pixel units mutually connected in parallel via a gate line, and each of the shift registers is configured to drive the pixels units of the corresponding display row via the gate line of the corresponding display row.

9. The display apparatus as claimed in claim 8, wherein each of the driving modules comprises a first shift register and a last shift register, wherein:
the first shift register of the first driving module is configured to receive an upward-driving signal, and each of the shift registers of the first driving module drives the pixel units of the corresponding display row in response to the upward-driving signal; and
the last shift register of the first driving module is configured to receive a downward-driving signal, and each of the shift registers of the first driving module drives the pixel units of the corresponding display row in response to the downward-driving signal.

10. The display apparatus as claimed in claim 8, wherein each of the driving modules comprises a first shift register and a last shift register, wherein:
the first shift register of the last driving module is configured to receive an upward-driving signal, and each of the shift registers of the last driving module drives the pixel units of the corresponding display row in response to the upward-driving signal; and
the last shift register of the last driving module is configured to receive a downward-driving signal, and each of the shift registers of the last driving module drives the pixel units of the corresponding display row in response to the downward-driving signal.

11. A display apparatus, comprising:
a display module having a first side and a second side opposite to the first side;
a plurality of driving modules respectively disposed next to the first side and the second side and electrically connected to the display module;
a plurality of sensing modules respectively disposed next to the first side and the second side and configured to sense an environment status surrounding the display apparatus; and
a process module electrically connected to the display module and the sensing modules, and configured to modulate the display module from a first status to a second status in response to the environment status;
wherein one of the driving modules disposed next to the first side, with reference to the display module, is substantially opposite to one of the sensing modules disposed next to the second side.

12. The display apparatus as claimed in claim 11, wherein the driving modules comprise a first driving module and a last driving module, the sensing modules comprise a first sensing module and a last sensing module, the first driving module is substantially opposite to the first sensing module, and the last driving module is substantially opposite to the last sensing module.

13. The display apparatus as claimed in claim 12, wherein the driving modules are adapted to drive the display module in a series sequence.

14. The display apparatus as claimed in claim 13, wherein the display module comprises a plurality of display rows, and the two adjacent driving modules are connected in series via two of the display rows of the display module.

15. The display apparatus as claimed in claim 14, wherein each of the display rows comprises a plurality of pixel units mutually connected in parallel via a gate line, each of the driving modules comprises a plurality of shift registers mutually connected in series, and each of the shift registers is electrically connected to the corresponding display row, so as to drive the pixels units of the corresponding display row via the corresponding gate line.

16. The display apparatus as claimed in claim 15, wherein each of the driving modules comprises a first shift register and a last shift register, wherein:
the last shift register of the first driving module is electrically connected to the first shift register of the driving module next to the first driving module via two gate lines;
the first shift register of the first driving module is configured to receive an upward-driving signal; and
the last shift register of the last driving module is configured to receive a downward-driving signal.

17. The display apparatus as claimed in claim 12, wherein the display module comprises a plurality of display rows, each of the driving modules comprises a plurality of shift registers mutually connected in series, and each of the shift registers is electrically connected to and is configured to drive the corresponding display row.

18. The display apparatus as claimed in claim 17, wherein each of the display rows comprises a plurality of pixel units being mutually connected in parallel via a gate line, and each of the shift registers is configured to drive the pixels units of the corresponding display row via the gate line of the corresponding display row.

19. The display apparatus as claimed in claim 18, wherein each of the driving modules comprises a first shift register and a last shift register, wherein:
the first shift register of the first driving module is configured to receive an upward-driving signal, and each of the shift registers of the first driving module drives the pixel units of the corresponding display row in response to the upward-driving signal; and
the last shift register of the first driving module is configured to receive a downward-driving signal, and each of the shift registers of the first driving module drives the pixel units of the corresponding display row in response to the downward-driving signal.

20. The display apparatus as claimed in claim 18, wherein each of the driving modules comprises a first shift register and a last shift register, wherein:
the first shift register of the last driving module is configured to receive an upward-driving signal, and each of the shift registers of the last driving module drives the pixel units of the corresponding display row in response to the upward-driving signal; and
the last shift register of the last driving module is configured to receive a downward-driving signal, and each of the shift registers of the last driving module drives the pixel units of the corresponding display row in response to the downward-driving signal.
